(19) United States
(12) Patent Application Publication
(10) Pub. No.: US 2015/0295612 A1
(43) Pub. Date: Oct. 15, 2015

(54) Mobile Device Radiation Reduction Shield

(71) Applicants: James Matthew Brancale, Ridgewood, NJ (US); Mark Vincent Brancale, Ridgewood, NJ (US)

(72) Inventors: James Matthew Brancale, Ridgewood, NJ (US); Mark Vincent Brancale, Ridgewood, NJ (US)

(21) Appl. No.: 14/253,858

(22) Filed: Apr. 15, 2014

(51) Int. Cl. H04B 1/3827; H04B 1/3888

(52) U.S. Cl. CPC H04B 1/3838; H04B 1/3888

(57) ABSTRACT

This invention is intended to provide a means to reduce the radiation emitted by Mobile Devices when used by people to make calls or left on when carried by people close their bodies. This is because the mobile device radiation has been shown to cause some cellular changes that are believed to cause cancer in the long run. The purpose of inventing this shield is to provide some limited level of reduction of this radiation for constant users of mobile devices in the hopes of reducing serious cellular damage in the short term from using these devices. While there is a way to completely block all radio/microwave radiation emitted by mobile devices, that complete block would also render the mobile device unable to make calls or connect to services, so the intent of this shield is to reduce exposure while still allowing people to make or receive necessary calls.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX (IF APPLICABLE)

Not Applicable.

### BACKGROUND OF THE INVENTION

The field of endeavor for this invention is Mobile Devices, which is currently not a U.S. patent classification or sub classification. This invention is intended to provide a means to reduce the radiation emitted by Mobile Devices, because this radiation has been shown to cause some cellular changes that are believed to cause cancer in the long run. Current mobile devices all emit radio, microwave radiation at variable levels as part of providing a clear connection for a call made by the user. However, users of mobile devices often spend too long holding these devices close to their heads while in conversation or wearing them too closely to their bodies carrying the device in their shirt, jacket, or pants pockets. Some manufacturers of these mobile devices have at times documented warnings in their product handbooks that state that it is not recommended to be placed within a certain distance from the user's head, stomach, etc. Unfortunately, most users globally do not read this fine print and do not heed this recommendation. Over the last 4-5 years, there have been a growing number of reports on television or on the internet describing the growing concern of the medical community around the potential link between prolonged close exposure to this radiation through the use of mobile devices placed right on the body and cellular damage and disease. In fact, reports have shown that the cellular risk and impact has been more significant when mobile devices are used by children because their skulls are not as thick.

### BRIEF SUMMARY OF THE INVENTION

This invention is intended to provide a means to reduce the radiation emitted by Mobile Devices when used by people to make calls or left on when carried by people close their bodies. This is because the mobile device radiation has been shown to cause some cellular changes that are believed to cause cancer in the long run. The purpose of inventing this shield is to provide some limited level of reduction of this radiation for constant users of mobile devices in the hopes of reducing serious cellular damage in the short term from using these devices. While there is a way to completely block all radio/microwave radiation emitted by mobile devices, that complete block would also render the mobile device unable to make calls or connect to services, so the intent of this shield is to reduce exposure while still allowing people to make or receive necessary calls. By reducing radiation exposure through providing blocking of these radio/microwaves at target points of the mobile device that is placed on the body, it is our hope that it would reduce the potentially harmful effects of this exposure on the body, especially in children.

### BRIEF DESCRIPTION OF THE DRAWINGS

FIG. 1 (of 2). Drawing of the Mobile Device Radiation Reduction Shield (Top View)

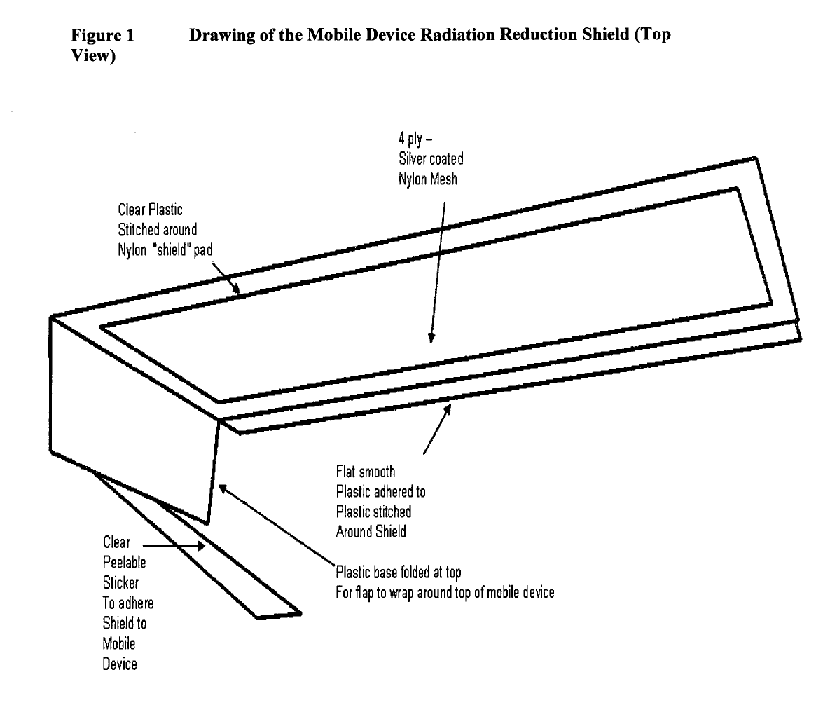

Brief Description: This is a view from the top of the Mobile Device Radiation Reduction Shield invented by James Matthew Brancale and Mark Vincent Brancale. The flap on the left of the drawing is used to adhere the shield to the mobile device. The silver coated nylon mesh inside the clear plastic case will sit on top of the front of the mobile device.

FIG. 2 (of 2). Drawing of the Mobile Device Radiation Reduction Shield (Bottom View)

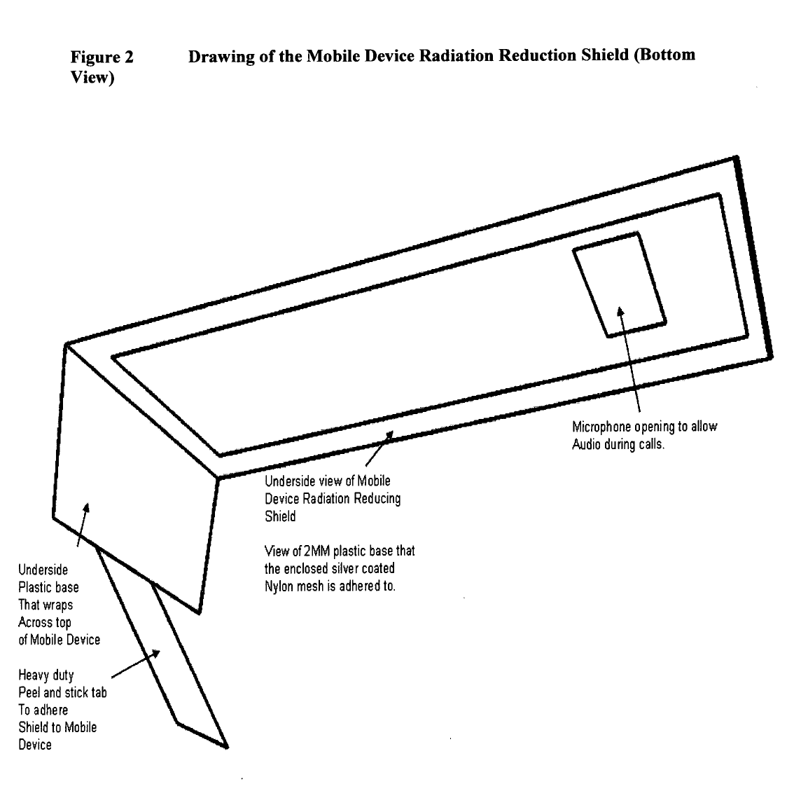

Brief Description: This is a view from the bottom of the Mobile Device Radiation Reduction Shield. There is an opening in the plastic case to allow sound to pass through the inner nylon mesh to impede audio quality.

### DETAILED DESCRIPTION OF THE INVENTION

The Mobile Device Radiation Reduction Shield invention consists of a soft flap that can be pulled over the front of the mobile device when used for talking on the device or pulled back when the user wants to surf the web, watch video's, chat, text, etc. It is soft and comfortable when holding the device for extended hours on you ears and head. It does not cover the cameras in the back of your device or block buttons on the top of your device. When the shield is used, the levels of radiation are reduced and the invention does not impede any audio you will need to hear or speak with the other party. The shield will also not in advertantly select any options on the screen.

To make this invention, you will need the following materials:
1 sheet of 2 mm thick plastic
1 sheet of clear sticker
1 yard of knit nylon with silver metal coating. (weight of 40 g/m²) (silver coating should be >99% pure and nylon should be tribal nylon yarn of Pa6-20Fl denier)
1 0.05 mm thick plastic bag
1 spool thread
1. Sheet of flexible plastic 2 mm thick, cut into a 3 in×6.5 in rectangle.
2. Fold the top of the ½ inch mark.
3. Attach a 2 in×¾ in clear sticker 0.25 inches from the top if he fold to make a tongue that the user will use to attach to their mobile device.
4. 2.5 in up from the bottom of the plastic rectangle (on the side that is not folded), cut a 1 in×0.5 in rectangle (make sure that the rectangle is centered left and right).
5. Cut a 12 in×6.5 in rectangle of silver mesh and fold into quarters to make a 4-ply pad.
6. Place pad into plastic bag and stitch around the border of the 3 in×6.5 in rectangle. Be careful not to stitch the silver coated nylon.
7. Cut between an ⅛^{th} in to a ¼ all around from the stitching.
8. Glue the top of the bag (using the ¼ in plastic from the stitching) containing the 4 ply silver coated nylon pad onto the folded part of the 6.5 in rectangle.
9. Glue the bag with the silver coated nylon pad onto the bottom of the plastic rectangle.

Currently, there is no shield like this in the marketplace. Some are gold stickers (like one sold on Amazon), others are devices that claim to create radio waves that cancel out the ones that are emitted by the mobile devices. What makes this shield different and a user friendly and safe invention is that:
1. You do not adhere the metal directly to the mobile device. Doing so could damage the screen or scratch the front of the mobile device, cause unintended entries on the mobile device screen, or even result in static electricity.
2. The plastic bag that it is contained in is soft and does not affect the silver coating on the nylon, so there is no loss of effectiveness from any washing, wiping, scratching, tearing of the material and silver coating on it, and it feels like a soft pad when the user holds the mobile device up to their ears and heads.
3. Because the shield does not encapsulate the whole mobile device, the device is still able to connect to services and your calls remain online and active while your exposure to the highly fluctuating and hi levels of the radio/microwaves are reduced.
4. Because the shield is not tied down to the bottom of the device and is made of very think plastic bag and a nylon mesh, you are able to both hear the caller and the caller is able to hear you—not interfering with your call.
5. Because the shield can be flipped back and pulled up and over the mobile device screen before putting to your ear and head, the user can do all the usual things needed to find a contact person, dial the number, etc. before placing it on their head and ear. Also, when the mobile device is not in use for calling, the cover can be pulled back so that they can play games, watch videos, etc.
6. Because the shield sits right on top of the screen, it helps to limit the amount of radio/microwave radiation that could get emitted from the front of the device.
7. The shield can be customized with designs and stickers as desired by the user as long as the stickers do not damage the plastic and are not too thick to impede audio capabilities.

1. The invention for this nonprovisional utility patent is the mobile device radiation reduction shield. It is the thoughtful and tested use, selection, design of the materials listed to make a user friendly, comfortable and safe shield that aims to reduce the radiation exposure of children and adults from use of mobile devices without stopping them from receiving or making calls.
